(19) United States
(12) Patent Application Publication
(10) Pub. No.: US 2023/0188482 A1
(43) Pub. Date: Jun. 15, 2023

(54) SYSTEMS AND METHODS FOR FACILITATING CHAT-BASED APPLICATION INTERACTIONS

(71) Applicant: DIREQT, INC., Seattle, WA (US)

(72) Inventors: MICHAEL JOHN WILLIS, Redmond, WA (US); WILLIAM WARREN MADDEN, Delray Beach, FL (US)

(73) Assignee: DIREQT, INC., Seattle, WA (US)

(21) Appl. No.: 17/924,227

(22) PCT Filed: May 7, 2021
(86) PCT No.: PCT/US2021/031291

§ 371 Date: Nov. 9, 2022

Related U.S. Application Data
(60) Provisional application No. 62/704,421, filed on May 9, 2020.

(51) Int. Cl. H04L 51/02; H04L 51/56

(52) U.S. Cl. CPC H04L 51/02; H04L 51/56

(57) ABSTRACT

A method for providing an asset over a network comprises receiving, by a first computing system from a client device, request to provide a digital asset over a network, the request including a network identifier and configuration information associated with the client device; determining, by the first computing system, one or more chatbots available to the client device based on the network identifier and the configuration information associated with the client device; generating, by the first computing system, the digital asset including an invocation scheme for deploying a chatbot of the one or more chatbots on the client device, the invocation scheme configured to connect the chatbot hosted on a second computing system to the client device through the first computing system; and providing, by the first computing system, the digital asset to the client device.

### CROSS-REFERENCE TO RELATED PATENT APPLICATIONS

The present application claims the benefit of and priority to U.S. Provisional Patent Application No. 62/704,421, filed on May 9, 2020, the entire disclosure of which is incorporated by reference herein.

### BACKGROUND

Businesses use text-based communications to communicate with customers for many purposes. Increasingly, text-based communication is powered by software agents (e.g., chatbots) that map user intent to pre-defined message flows. While the message flows can be made arbitrarily complex, in practice the content is predetermined, perhaps augmented with personalization information from a Customer Relationship Management (CRM) system or other context.

### SUMMARY OF THE INVENTION

As present, different networks such as cellular messaging networks and applications such as messaging applications have different interfaces for integrating third party content such as chatbots. For example, a first messaging application operating on a first cellular messaging network may utilize a first application programming interface (API) to integrate a first chatbot and a second messaging application operating on a second cellular messaging network may utilize a second API to integrate the first chatbot. Providers of third party content such as chatbots may wish to deploy content on a number of different networks and/or a number of different applications. However, doing so may require customizing the chatbots for integration with each different deployment platform (e.g., depending on a device configuration such as an operating system, a type of cellular network, a type of messaging application, a location of a device accessing the chatbot, etc.). Therefore, integration with each different deployment platform may be infeasible. Additionally, piecemeal integration with different deployment platforms may limit functionality associated with chatbots. For example, a chatbot deployed in this manner may be unable to provide dynamic promotional content to a user and/or facilitate measuring interactions associated with the chatbot. Therefore, there exists a need for systems and methods to provide unified and/or standardized deployment of chatbots to networks, messaging applications, and/or other deployment platforms (e.g., webpages, etc.).

The systems and methods described herein propose a solution to the technical shortcomings of present chatbot integration mechanisms by enabling a central repository/platform for the deployment, promotion, and management of chatbots in disparate contexts such as over non-conformed cellular networks or messaging applications. The solution presented herein further enables tracking of user interactions associated with deployed chatbots to provide data useful for optimization of business objectives, such as promotional or advertising success through click tracking, interaction tracking, and conversion tracking. Such functionality provides businesses with a mechanism to increase revenue, improve customer retention, and achieve other important objectives.

In one embodiment, a method for providing an asset over a network comprises receiving, by a first computing system from a client device, a request to provide a digital asset over a network, the request including a network identifier and configuration information associated with the client device; determining, by the first computing system, one or more chatbots available to the client device based on the network identifier and the configuration information associated with the client device; generating, by the first computing system, the digital asset including an invocation scheme for deploying a chatbot of the one or more chatbots on the client device, the invocation scheme configured to connect the chatbot hosted on a second computing system to the client device through the first computing system; and providing, by the first computing system, the digital asset to the client device.

In some embodiments, the digital asset enables a user using the client device to interact with the chatbot hosted on the second computing system. In some embodiments, the network includes a cellular network. In some embodiments, deploying the chatbot of the one or more chatbots on the client device includes causing the client device to initiate a connection with the chatbot within an application of the client device. In some embodiments, deploying the chatbot of the one or more chatbots on the client device includes causing the client device to display a user interface gallery which includes the chatbot. In some embodiments, the digital asset includes a pointer to the first computing system. In some embodiments, providing the digital asset to the client device includes embedding the digital asset in a HyperText Markup Language (HTML) asset.

In another embodiment, a system for providing access to an asset comprises one or more processors coupled to memory, the one or more processors configured to receive, from a client device, a request to provide a digital asset over a network, the request including a network identifier and configuration information associated with the client device; determine one or more chatbots available to the client device based on the network identifier and the configuration information associated with the client device; generate the digital asset including an invocation scheme for deploying a chatbot of the one or more chatbots on the client device, the invocation scheme configured to connect the chatbot hosted on a second computing system to the client device through the system; and provide the digital asset to the client device.

In some embodiments, the digital asset enables a user using the client device to interact with the chatbot hosted on the second computing system. In some embodiments, the network includes a cellular network. In some embodiments, deploying the chatbot of the one or more chatbots on the client device includes causing the client device to initiate a connection with the chatbot within an application of the client device. In some embodiments, deploying the chatbot of the one or more chatbots on the client device includes displaying a user interface gallery which includes the chatbot. In some embodiments, the digital asset includes a pointer to the system. In some embodiments, providing the digital asset to the client device includes embedding the digital asset in a HyperText Markup Language (HTML) asset.

In another embodiment, a non-transitory computer-readable storage medium having instructions stored thereon that, when executed by one or more processors, cause the one or more processors to perform operations comprising receiving, from a client device, a request to provide a digital asset over a network, the request including a network identifier and configuration information associated with the client device; determining one or more chatbots available to the client device based on the network identifier and the configuration information associated with the client device; generating the digital asset including an invocation scheme for deploying a chatbot of the one or more chatbots on the client device, the invocation scheme configured to connect the chatbot hosted on a second computing system to the client device through the one or more processors; and providing the digital asset to the client device.

In some embodiments, the digital asset enables a user using the client device to interact with the chatbot hosted on the second computing system. In some embodiments, the network includes a cellular network. In some embodiments, deploying the chatbot of the one or more chatbots on the client device includes at least one of (i) causing the client device to initiate a connection with the chatbot within an application of the client device or (ii) displaying a user interface gallery which includes the chatbot on the client device. In some embodiments, the digital asset includes a pointer to the one or more processors. In some embodiments, providing the digital asset to the client device includes embedding the digital asset in a HyperText Markup Language (HTML) asset.

It is to be understood that both the foregoing general description and the following detailed description are exemplary and explanatory and are intended to provide further explanation of the disclosure as claimed.

### BRIEF DESCRIPTION OF THE DRAWINGS

The accompanying drawings constitute a part of this specification, illustrate an embodiment of the disclosure, and together with the specification, explain the methods, systems disclosed herein.

FIG. 1 is a block diagram illustrating a system for facilitating chat-based application interactions, according to an embodiment.

FIG. 2 is a block diagram illustrating a system for a messaging-as-a-product-level (MaaP) chatbot platform for facilitating chat-based application interactions, according to an embodiment.

FIG. 3 is a flow chart illustrating a method generating a content item associated with a chatbot, according to an embodiment.

FIG. 4 is a flow chart illustrating a method for serving a chatbot, according to an embodiment.

FIG. 5 is a flow chart illustrating a method for serving a digital asset to a client device, according to an embodiment.

FIG. 6 is an illustrative example of chatbot messaging integration in an application, according to an embodiment.

FIG. 7 is an illustrative example of chatbot messaging integration in a web browser, according to an embodiment.

FIG. 8 is an illustrative example of a menu for managing one or more chatbots, according to an embodiment.

FIG. 9 is an illustrative example of a registry for one or more chatbots, according to an embodiment.

FIG. 10 is an illustrative example of a menu for managing one or more sponsorships associated with one or more chatbots, according to an embodiment.

FIG. 11 is an illustrative example of a menu for monitoring the operation of one or more chatbots, according to an embodiment.

FIG. 12 is an illustrative example of a menu for promoting one or more chatbots, according to an embodiment.

FIG. 13 is an illustrative example of a dashboard for monitoring the operation of one or more chatbots, according to an embodiment.

### DETAILED DESCRIPTION

Reference will now be made to the embodiments illustrated in the drawings, and specific language will be used here to describe the same. It will nevertheless be understood that no limitation of the scope of the methods/systems is thereby intended. Alterations and further modifications of the inventive features illustrated here, and additional applications of the principles of the methods/systems described herein as illustrated here, which would occur to a person skilled in the relevant art and having possession of this disclosure, are to be considered within the scope of the methods and systems described herein.

Referring now generally to the Figures, disclosed herein are systems and methods for facilitating chat-based application interactions. In many scenarios, providers of third-party content such as chatbots may wish to serve the third-party content to users. For example, a retailer having an online chatbot may wish to serve the chatbot to user devices associated with users so that the users may interact with the chatbot. However, the mechanism for serving the chatbot to users may differ depending on the context of each user device and/or how the user device accesses the chatbot. For example, a first user device may operate on a first operating system requiring a first integration with the chatbot and a second user device may operate on a second operating system requiring a second integration with the chatbot. It may be infeasible or prohibitively resource intensive for a provider of third-party content to integrate a chatbot with every variation of user device. Therefore, there may be a need for systems and methods to provide uniform/standardized integration of chatbots with user devices such as mobile devices and/or user computing devices.

One solution relates to a server hosting a centralized/standardized repository for one or more chatbots. For example, a server may generate a chatbot gallery for hosting a number of chatbots from a number of third-parties on a network such as a cellular network such that user devices on the network may interact with the number of chatbots. In various embodiments, each of the number of chatbots may be hosted on a computing system associated with a third-party and the server may connect each of the number of chatbots to a user device while abstracting the complexities of integrating each of the number of chatbots from the respective third-party. For example, the server may act as a middleman between a computing system of a third-party and a user device, translating inputs and outputs associated with the chatbot from the computing system into a format required by the user device and/or a network the user device is operating on.

In various embodiments, the server facilitates a number of advantages over existing systems. For example, the server may aggregate information about chatbots and/or user interactions with chatbots, thereby enabling centralized management over a chatbot deployed on a number of different user devices and/or networks (e.g., rather than having to manage each integration of the chatbot with different devices/networks separately, etc.). Moreover, the server may facilitate digital advertising campaigns for content providers to promote content. For example, a content provider may launch an advertising campaign using the server to cause the server to promote usage of a chatbot associated with the content provider. Additionally or alternatively, the server may dynamically build the content of a network directory in real time (e.g., using rules based on subscriber and environmental attributes, etc.), thereby enabling dynamic network content. In various embodiments, the server abstracts the process of initiating a conversation between a user using a user device and a chatbot, thereby enabling a wider range of chatbot applications such as web link (e.g., “click to chat” buttons, etc.) to launch a chatbot.

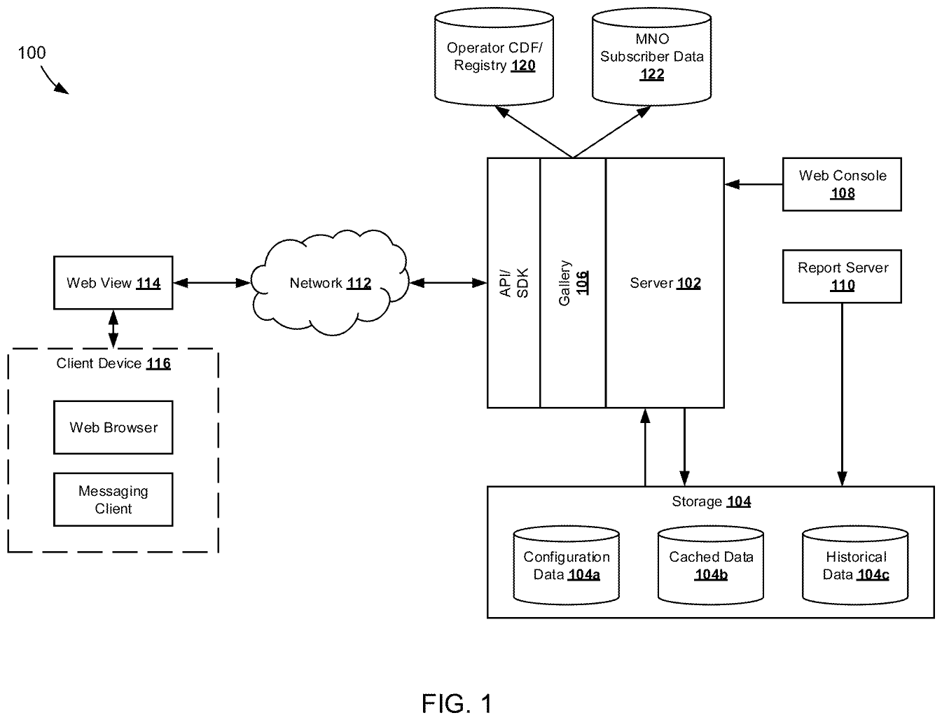

Referring now to FIG. 1, and in brief overview, a block diagram illustrating an embodiment of system 100 for facilitating chat-based application interactions is shown. System 100 may integrate one or more chatbots with a network and/or end user devices such as a mobile device and/or may provide a unified chatbot gallery to facilitate browsing, discovery, and interaction with chatbots available on the network. System 100 includes client device 116 that communicates with web view 114, server 102, and gallery 106 via network 112. In some embodiments, system 100 includes a SMS system and/or a RCS system (or other messaging system). For example, client device 116 may communicate with a RCS system via network 112. System 100 also includes server 102 that facilitates providing chatbot functionality to client device 116. For example, server 102 may provide additional content in response to a request (e.g., a request for a chatbot service, etc.) from a SMS system and/or a RCS system (or other messaging system). Server 102 may provide a digital asset such as a content item functionality created through the implementation of an application programming interface (API), or provided as a software development kit (SDK), that connects an existing software chatbot to client device 116 (e.g., via a web browser and/or a messaging client, etc.). The API may be implemented as web services, and provide for configuration and runtime (e.g., advertisement fetch) capabilities. The SDK may be a publicly documented Software Development Kit to allow easy integration with various programming languages, such as Python or HTTP. The SDK typically exists as a wrapper over the API interfaces, but also provides performance optimizations and additional functionality related to privacy or security. The API/SDK may be installed on a processing device such as server 102, which may provide web-based services to the existing chatbot.

Still referring to FIG. 1, and in greater detail, server 102 may include a central processing unit (CPU), or other processing device configured to run an operating system on which the API/SDK may be installed. Generally, server 102 is communicatively coupled to a memory and configured to execute instructions stored in the memory. Such instructions may be altered by the APFSDK. Server 102 may connect to storage 104. In various embodiments, storage 104 is persistent computer storage. Storage 104 may be cloud storage or a physical hard drive configured to store relevant data, and may be connected to server 102 directly, by a local area network (not shown) or by network 112. Storage 104 may include configuration database 104a to store matching rules, selection rules, and messaging component templates. Configuration database 104a may additionally store configuration data for users, moments, and components. Storage 104 may further include cached database 104b, configured to store data used for quick lookups. Storage 104 may further include historical database 104c, which may be configured to hold historical information, which may be used for report generation.

Still referring to FIG. 1, system 100 may also include web console 108 that provides role-based access to functionality related to configuration database 104a and reporting. Web console 108 may provide a web interface that customers may use to define moments, rules, components, as well as access real-time performance reports. Moments are specific points of a chatbot conversion where system 100 can be configured to insert a component, which may be text, images, and/or actions to display to the user for a particular moment. A customer may use web console 108 to specify components with particular moments, and set rules and frequency caps to determine how best to enhance the message returned to an end-user interacting with the chatbot.

In various embodiments, web console 108 facilitates managing one or more chatbot galleries. For example, a customer may add or remove a chatbot from a chatbot gallery using web console 108. In various embodiments, web console 108 facilitates generating promotional/advertising campaigns associated with one or more chatbots. For example, a customer may generate an advertisement campaign to promote one or more chatbots managed through web console 108. In some embodiments, a customer may retrieve an HTML link from web console 108 which directs users to a chatbot gallery. For example, a customer may embed a link from web console 108 in a website to enable users to access a chatbot gallery, launch a chatbot conversation, or other actions via the link.

Still referring to FIG. 1, web view 114 may fetch, or send a fetch request to server 102. A fetch request is a request for dynamic content in response to the detection of a moment, which is facilitated by the respective agent, and often includes a customer or subscriber identifier to identify the originating chatbot agent, a moment identifier, and targeting parameters. The targeting parameters may include key-value pairs used as inputs to rules within server 102. For example, the targeting parameters may be used by server 102 to identify one or more users to promote a chatbot to. Customers may define their own targeting parameters. The information included in the fetch request may be used by server 102 to apply customer-specific rules to determine which chatbots to display to users within a chatbot gallery. Such rules may be specifications for how to use the moment and targeting parameters supplied in the fetch request to select a content item (e.g., a chatbot, a chatbot gallery, etc.) to be served to an end user. Server 102 may provide an interface that mirrors the interface used to connect a chatbot agent to a messaging gateway, network, or user device. The chatbot agent is altered to send messages to server 102, rather than a messaging gateway. Server 102 may check the rules configured in web console 108 in real-time against traffic received from client device 116, and may take action as necessary. The rules may be used to determine which chatbots to deliver to a chatbot gallery of a client device such as client device 116.

Still referring to FIG. 1, system 100 may further include report server 110 that collects information generated by other system components, such as fetch requests, click events, and conversions, and intelligently processes it such that it can be used to understand and optimize business objectives via real-time and/or summary (batch) reports. Report server 110 may be further configured to deliver the reports via various transports (email, text message, cloud storage, ftp, via web console 108), to provide additional diagnostics information to customers.

Network 112 may be a wireless or a wired connection, and may further serve to connect server 102 to a SMS system, RCS system, or other system configured to host chatbot agents. The SMS system (not shown) may host a SMS agent which may include a customer-specific software application that integrates with SMS gateways. The RCS system (not shown) may host an RBM agent which may include a customer-specific software application that integrates with Messaging as a Product (MaaP) gateways. In various embodiments, the gateways are web services providing bidirectional communication services allowing a company to communicate with a subscriber over a particular channel, such as SMS, RCS, or the like, and are often provided by a third party. It should be understood that system 100 may include other systems in addition to, or instead of, those explicitly shown in FIG. 1. For example, system 100 may include another system which may host another type of chatbot agent on the other chat server that may be compatible with the APIs of server 102. In various embodiments, such agents are existing platform-specific services typically owned by the customer. An agent is primarily responsible for managing the flow of messages between a subscriber (user) and a company, and may be built atop a commercial provider or may be a custom implementation. In order to differentiate between the chatbot agents of different customers, server 102 may differentiate between networks, which are collections of moments, rules, components, and associated user accounts logically connected with a single customer property. A user account may be associated with more than one network if, for example, the customer manages multiple independent messaging channels.

In many cases, a chatbot is accessed by a web browser and/or messaging client via client device 116. In various embodiments, web view 114 may be capable of connecting client device 116 to network 112, and thus to a chatbot agent hosted by client device 116. When displaying a chatbot gallery to the end user, client device 116 may allow any chabot agent currently connected to a web browser and/or application to display content in the chatbot message exchange. In various embodiments, web view 114 may retrieve information associated with one or more chatbots from gallery 106 and display a user interface such as a chatbot gallery to a user based on the retrieved information. Web view 114 may package the information from gallery 106 in a web compatible format such as HTML, JavaScript, and/or CSS to facilitate rendering content on an application such as a web browser. For example, web view 114 may retrieve one or more parameters associated with client device 116 such as a web browser type, a location, and/or a network type and may deploy a chatbot from gallery 106 to client device 116 by generating a content item for client device 116 that is formatted according to the one or more parameters. Additionally or alternatively, web view 114 may include a gallery packaged in a web compatible format that can be displayed in any application (e.g., a web browser, a messaging application, etc.) capable of rendering web content. For example, web view 114 may include a chatbot gallery generated by server 102 and deployed to client device 116.

In various embodiments, server 102 determines the contents of a chatbot gallery according to parameters associated with a network. For example, an operator of a mobile communication network such as a cellular network may manually choose which chatbots to include in a gallery hosted on the cellular network. In various embodiments, server 102 provides to users wishing to access the chatbot gallery a link to the chatbot gallery such that the users may access the chatbot gallery. For example, server 102 may maintain a number of chatbot galleries each having a number of chatbots on a network and may provide a user with a link to access a specific chatbot gallery having a specific set of chatbots.

Additionally or alternatively, each gallery may be curated independently. For example, an operator of a mobile communication network may define some number (e.g., greater than one, etc.) of chatbot galleries (e.g., each being identified with a unique identifier, etc.) and may assign some set of chatbots to each gallery. In various embodiments, server 102 generates a data structure associated with each chatbot gallery. For example, server 102 may generate a data structure for a chatbot gallery including (i) information specifying which chatbots are contained in the gallery (e.g., via SIP URI's, etc.) and (ii) an indication of a language supported by the chatbot gallery (e.g., “pl=en” for a chatbot gallery supporting English, etc.). In various embodiments, server 102 generates a link to access the chatbot gallery such as: “https://operator.chatbot.gallery?pl=en” where “pl” corresponds to a supported language and “operator” is a name of a network provider. In various embodiments, server 102 provides the link to a client device so that the client device can access the chatbot gallery.

In some embodiments, server 102 configured the link to personalize the chatbot gallery to a user's preferences. For example, the link may query a preferred language of a user device (e.g., from the device settings, etc.) and may adapt the chatbot gallery to the preferred language. For example, a user device may request a chatbot gallery using a link provided by server 102, and server 102 may (i) identify a network provider based on the link, (ii) determine which chatbot galleries are provided on a network of the network provider, (iii) discard any galleries not supporting the user's preferred language, and (iv) serve a chatbot gallery to the user based on the determined parameters. In various embodiments, server 102 generates links to chatbot galleries having arbitrary property-value pairs to support serving chatbot galleries based on different context parameters (e.g., according to device type, geography, past behavior, etc.). For example, link “https://networkl.chatbot.gallery/?pl=en&ho=234015&client vendor=SEC&client version=RC SAndr-6.0” may be used by server 102 to identify a set of chatbot galleries owned by “networkl” having a preferred language of English, a specific HNI, a specific mobile messaging client vendor, and a specific client version.

In some embodiments, server 102 determines the contents of each chatbot gallery dynamically. For example, server 102 may maintain a registry of available chatbots including metadata about each chatbot including information about various invocation methods and server 102 may determine which chatbot to server based on the specific invocation methods available on a device. For example, server 102 may maintain a data structure element including a chatbot identifier (e.g., a SIP URI, etc.), a mobile operator identifier (e.g., a HNI, etc.), one or more country codes and/or operator codes associated with areas where the chatbot is available via SMS (e.g., a SMS shortcode, a 10-digit longcode, etc.), and/or the like.

A non-limiting example of server 102 determining which chatbots to serve to a user follows: server 102 may receive a request for a chatbot gallery from a client device. Server 102 may build a set of attributes about the request by inspecting (i) information in the request query string and/or headers, (ii) information about the subscriber that may have been stored from a previous request (e.g., extract information from a subscriber database, etc.), (iii) information that may be obtained by querying the user (e.g., by serving a web-form request for a user to enter an identifier such as a phone number, etc.), (iv) information about network parameters such as RCS compatibility (e.g., via a device capability check, etc.). Server 102 may query (i) a mobile network of the client device (e.g., a HO/HNI of a client device, etc.), (ii) a country of the client device, (iii) a preferred language of the client device, (iv) an operating system of the client device, and/or (v) the client device RCS compatibility. Server 102 may determine a set of compatible chatbots by (i) building a list of channels (e.g., invocation methods, etc.) supported by the client device based on the queried parameters, (ii) filtering a list of chatbot based on the list of channels supported by the client device, and/or (iii) selecting a preferred channel for each remaining chatbot based on the chatbot metadata. In various embodiments, server 102 may render a gallery including links to the preferred channel for each compatible chatbot.

Server 102 may interact with one or more external computing systems via gallery 106. For example, gallery 106 may provide APIs for accessing a chatbot registry, interaction tracking dashboard, and/or reporting interface by an external computing system such as an advertiser computing system. As another example, gallery 106 may include a web interface such as a dashboard that facilitates a customer to review and manage the operation of one or more chatbots hosted by server 102. In various embodiments, gallery 106 communicates with operator CDF/Registry 120 and/or MNO subscriber database 122. For example, gallery 106 may provide an API to allow a customer to integrate a database with server 102 to receive interaction data generated based on user interactions with one or more chatbots deployed via server 102. Operator CDF/Registry 120 may store customer data such as information on business chat applications. In some embodiments, system 100 does not include operator CDF/Registry 120. MNO subscriber database 122 may store customer data such as subscriber-specific attributes. For example, MNO subscriber database 122 may store a device configuration (e.g., an operating system version, interaction data, etc.) of a client device 116 that is used to interact with a chatbot hosted by server 102.

10044) In some embodiments, server 102 launches chatbot conversations from a user interface such as a chatbot gallery. Additionally or alternatively, server 102 may launch a chatbot conversation within an application running on client device 116 (e.g., a mobile application provided by a third party, etc.). In some embodiments, server 102 augments an existing message stream associated with client device 116. For example, server 102 may utilize a fetch service that determines whether a message should be inserted or altered, selects an appropriate alteration or insertion based on user-defined rules, and performs a manipulation of the original message to insert/modify it. Server 102 may also be programmed to provide an interaction-tracking service that detects and tracks interactions that chatbot users have with digital assets/content delivered by the system, including conversion events that may occur in a secondary medium, such as a website or interactive voice response (IVR) system.

In some embodiments, system 100 provides a multi-tenant web application, which means that multiple customers' data may be loaded into the same instance of the various databases used by the system. To keep each customer's data separate from each other's, all data records may have a field named “network”, which uniquely identifies a particular customer network. The system has a data access layer between the databases and the program logic. This data access layer ensures that requests for data from the databases are only provided access to records with the appropriate network. For example, when a customer signs into web console 108, web console 108 authenticates the customer before allowing any requests of the API on advertisement server 102. The API uses the authenticated customer identification to provide the data access layer with the appropriate network for the customer. The data access layer will only process records that match the given (authenticated) network.

For simplicity, the rest of this document will omit the “network” property from the definitions of data records. It should be assumed that this property is always present in the database.

While described as having server 102, it should be understood that the components of system 100 are capable of dealing with any type of messaging component on behalf of a customer. Customers use system 100 not just to serve chatbot galleries and facilitate chatbot conversations, but also to serve revenue-generating advertisements such as chatbot promotions (e.g., promoting user interaction with specific chatbots via various means such as displaying the specific chatbots higher in a light of chatbots, etc.). That said, for convenience advertisement serving is used herein to describe the functionality of system 100.

A customer provisions access to the functionality of system 100 by creating one or more accounts using the public-facing web console 108. Multiple user accounts may be associated with a particular network, and those user accounts may be either read-only or read-write. Once an account has been provisioned, one or more API keys can be obtained from web console 108. API keys are specified in API calls (or indirectly, via the SDK) and identify the customer's network in interactions with services of system 100. The customer uses web console 108 to specify moments, rules, and components (described below) that comprise the configuration data for the customer-specific network that together determine what messages will be delivered to customers in what situations.

In various embodiments, web console 108 facilitates generating advertisement campaigns associated with one or more chatbots. For example, a customer may use web console 108 to create an advertising account and purchase sponsorship of a chatbot in a chatbot gallery hosted by server 102. For example, brand X can create an advertising account with web console 108. If brand X has a chatbot available on Carrier Y then brand X may create a purchase order for a certain number of started conversations through a directory managed by Carrier Y. The purchase order may specify a chatbot to promote, the number of conversations to start, and a bid price for the conversation. Server 102 may record the purchase order in an account owned by Carrier Y and server 102 may include the promoted chatbot in decisions made in response to requests on a realtime API, thereby enabling the chatbot sponsorship to be displayed in a messaging application of a client device.

With an account provisioned and an API key, the customer adds one or more hooks to their chatbot agent. Hooks are typically created by inserting a call to the appropriate fetch routine provided by the SDK into the software powering the chatbot. When using a commercial chatbot platform, hooks may be provided using a platform-specific manner, such as by adding a label to a particular point in a dialog flow chart.

Hooks may be used by the chatbot agent as a way to notify server 102 that some particular point in a customer conversation has been reached (or a particular action has occurred), and to allow server 102 to determine based on the current configuration and runtime context, whether any actions should be taken (e.g., such as delivering content to a user, etc.). This process may be referred to as a fetch (or fetch request). When handling a fetch request, server 102 looks at the context of client device 116 and/or a user interaction with a chatbot (e.g., specific moment and targeting parameters specified by the fetch request, etc.), compares them with the rules that have been configured by the customer and with historical information recorded about previous interactions in historical database 104c to determine if there is a digital asset and/or content that would be appropriate to deliver to the customer. Additionally or alternatively, server 102 may record information about a client device and/or a user interaction with a chatbot and/or chatbot gallery in response.

1005.21 The typical embodiment is for the hook to be integrated directly into a customer's chatbot agent by way of the SDK for the customer platform. The SDK can integrate directly with the gateway interfaces provided by a SMS system, RCS system, or other system and perform client-side functionality that improves performance.

If the SDK cannot be used, for example if the chatbot agent is written in an unsupported programming environment or using a third-party platform, the integration may make direct use of the APIs, which provide essentially the same functionality as the SDK but with more effort required on the part of the customer. It is also possible to integrate the hook in the gateway itself of a system via a custom integration of the gateway. This has the benefit of being able to enable the functionality of system 100 for a large number of chatbots without having to make any customer-specific changes. For example, the gateway could provide the functionality of system 100 to its customers allowing them to insert ads or other messages into conversations.

Finally, the hook can be configured such that it mimics the interface provided by the gateway, essentially acting as a man-in-the-middle between the chatbot agent and the gateway. This has the benefit of not requiring any changes to the chatbot agent or gateway other than minor configuration changes, such as changing the URL used by the chatbot agent to communicate with the gateway through the API/SDK.

If it finds an appropriate component, server 102 performs any dynamic processing appropriate (for example, a component may use a templated string, into which a customer's name should be inserted at runtime), and converts it from an internal data format into a format specific to the gateway being used by the chatbot agent, and returns it to the chatbot agent. The chatbot agent uses the services of the gateway to deliver the message to the customer.

When the customer interacts with the message, for example by following links in a message or otherwise interacting with a message, these interactions are tracked by server 102. Interaction tracking is often done by re-writing customer-supplied URLs to redirect through server 102, but in some cases may involve the SDK interacting with the gateway. For example, when an RCS message is delivered to a subscriber, the RCS gateway may notify the customer agent when the subscriber has read the message. This “read receipt” notification may be intercepted by the SDK running on the agent, and information about the event is forwarded to server 102 using the API.

When a subscriber follows a link from a message provided by server 102, it is generally redirected through an interaction-tracking service. This allows the click event to be tracked, and also provides an opportunity to provide the subscriber's user-agent with an HTTP conversion-tracking cookie. If the customer has a website on which product purchases or other goals may be fulfilled by subscribers, the customer can use the API key provided earlier to put a tracking pixel or snippet of JavaScript on the goal website that directs the subscriber's user-agent to make a web request to server 102. This allows server 102 to inspect the cookies on the user agent, and record a conversion associated with the subscriber if appropriate.

Every interaction between the chatbot agent and server 102, such as fetch requests, and interactions between subscribers and components, for example clicks and conversions, are recorded in historical database 104c, enabling server 102 to group the various events in such a manner that it can determine, for example, the relative click-through and conversion rates for different components using the same rule. Information such as this can be displayed by web console 108 so that the customer can view reports showing the volume and performance of their network, and optimize future delivery.

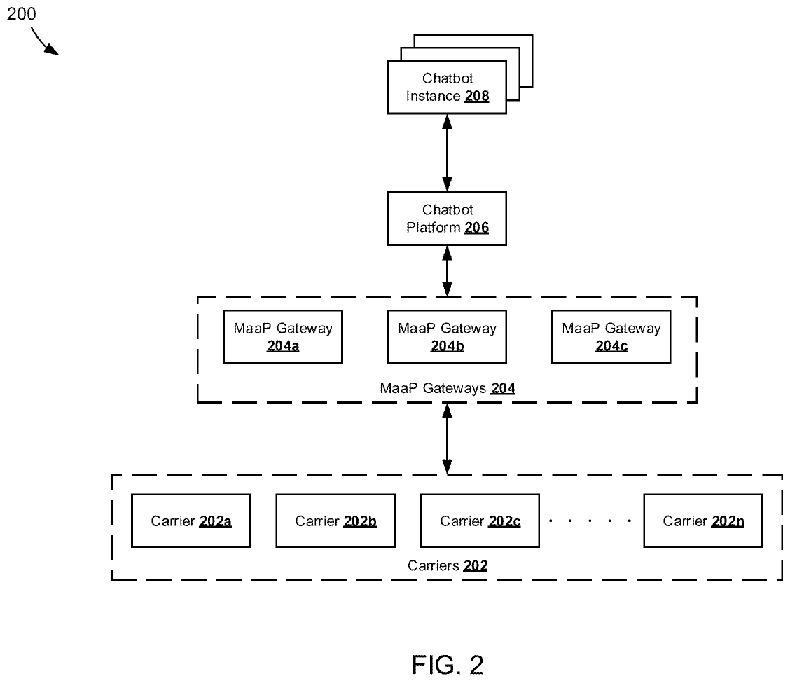

FIG. 2 is a block diagram illustrating an integration embodiment 200 of system 100 providing messaging-as-a-product-level (MaaP) chatbot platform for augmenting message streams, according to an embodiment. Text-based communications between a human and a chatbot often relies on multiple “back-and-forth” messages to accomplish a task. When adding a promotion or advertisement, it is desirable that the user can interact with the promotion in a similar way. For example, the user should be able to have a “side conversation” with the promotional content. Such a side-conversation would not normally be possible with a statically-defined intent-based conversation agent, because the information necessary to maintain state about the conversation must be known ahead of time.

Embodiment 200 allows for dynamically-inserted messaging components to have multiple interactions between the messaging component and a human user without modifying the underlying message script. This is done by essentially “pausing” the statically-defined conversation when a user interacts with a dynamically-inserted messaging component, and only resuming the original conversation when a specific event occurs. In order to pause the original conversation, the code that mimics the messaging gateway interface temporarily re-routes the message traffic that would normally flow between the human and the software agent such that it flows from the human to a software agent defined and controlled by a system such as system 100 of FIG. 1. For example, in embodiment 200, chatbot platform 206 interfaces with a number of MaaP gateways 204. During a particular chatbot instance 208 with an end-user, chatbot platform 206 may receive a request to augment the content in chatbot instance 208. While the current conversation of chatbot instance 208 may be handled by MaaP gateway 204a, the chatbot platform 206 may reroute the request to a second MaaP gateway, such as MaaP gateway 204b such that the request can be handled without needing to pause the present interaction. This mechanism allows, for example, one company to “transfer” a conversation to a different software agent, potentially implemented by a completely different company, such as switching from carrier 202a to carrier 202b, without the user being required to change contexts.

In practice, many useful tasks can be accomplished with a scheme that allows for only a single additional back-and-forth message transaction between the user and the smart messaging component. For example, a promotion for a company service may be tapped on by a user. In response, a new messaging component could be presented that asks the user to enter their zip code, email, phone number, or some other type of information. The smart messaging component can collect this information, write a confirmation message, and then return the user to the original state of the conversation that occurred before they interacted with the smart messaging component.

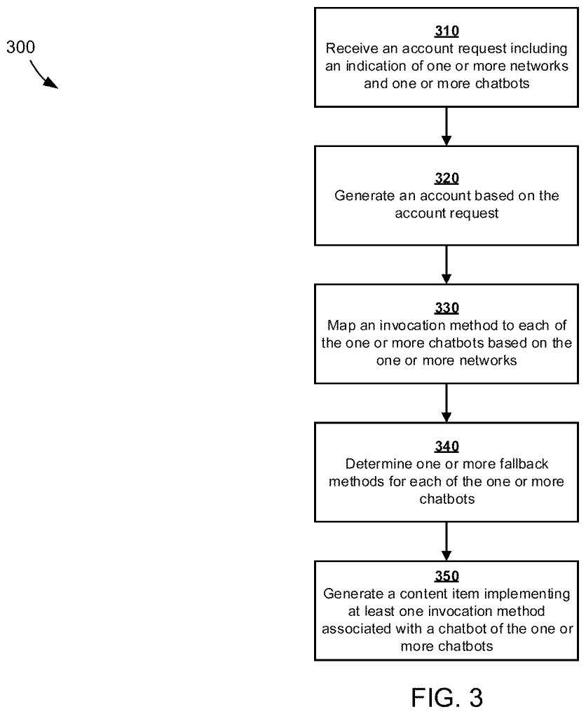

Referring now to FIG. 3, method 300 for generating a content item associated with a chatbot is shown, according to an exemplary embodiment. In various embodiments, one or more components of system 100 such as server 102 performs method 300. For example, server 102 may receive a request from a customer computing system to deploy a chatbot to a cellular network chatbot registry and may perform method 300 to generate a content item for implementing the chatbot on the cellular network. At step 310, server 102 may receive an account request including an indication of one or more networks and one or more chatbots. For example, step 310 may include receiving a request to integrate a chatbot hosted by a third party on a mobile communication network directory such that the chatbot is discoverable by and interactive with users of the mobile communication network. In some embodiments, the request includes a chatbot identifier such as a session initiation protocol (SIP) uniform resource identifier (URI) specifying a network location of a chatbot service (e.g., a server implementing a chatbot, etc.).

At step 320, server 102 may generate an account based on the account request. In various embodiments, the account is associated with a source of the request. For example, server 102 may maintain an account for each customer (e.g., each party utilizing server 102 to integrate a chatbot with a platform such as a mobile communication network, a messaging application, and/or a website, etc.). In various embodiments, the account facilitates the customer to manage the operation of one or more chatbots. For example, a customer may generate a promotional campaign using the account to preferentially display content associated with a chatbot to users (e.g., via an advertisement, by displaying the chatbot higher in a list of chatbots, etc.). As another example, a customer may view analytics associated with the operation of a chatbot via the account such as a conversion rate and/or a conversation count associated with the chatbot.

In various embodiments, step 320 includes associating metadata with a chatbot such as tagging a chatbot with one or more tags. For example, a customer may tag a chatbot with “sports” or “food” tags to facilitate grouping the chatbots. As another example, server 102 may generate a chatbot gallery within a messaging application of a client device such as client device 116, and may facilitate a user to filter chatbots available on their network based on the tags.

At step 330, server 102 may map an invocation method to each of the one or more chatbots based on the one or more networks. For example, server 102 may determine an implementation scheme for deploying the one or more chatbots on the one or more networks using an API/SDK as described above according to parameters associated with the one or more networks. As another example, server 102 may retrieve, from a chatbot directory function (CDF) or chatbot information function (CIF) of a network, a number of parameters used for integrating a chatbot with the network. The invocation method may include a deep-link URL, an API implemented by a messaging platform, an operating system method (e.g., a command from a command library associated with an operating system of a mobile device, etc.), and/or the like. In various embodiments, server 102 maintains a data structure such as a database mapping network identifiers to corresponding invocation methods and server 102 determines the appropriate invocation method using a lookup of the data structure.

At step 340, server 102 may determine one or more fallback methods for each of the one or more chatbots. For example, server 102 may implement one or more rules of the format “if X then Y,” where X and Y include invocation methods. As a non-limiting example, a rule may read “if chatbot A is unavailable on mobile network #1 then launch chatbot A via a web interface.” As another non-limiting example, a rule may read “if chatbot A is unavailable on mobile network #1 then make chatbot A reduced capability version available via SMS.” In various embodiments, the one or more fallback methods describe mechanisms for handling situations in which a particular chatbot (or chatbot implementation) is not available on a platform such as a network. For example, a particular chatbot may not be available on a platform based on a context of a client device accessing the chatbot such as a network the client device is operating on, the client device type, an operating system version of the client device, whether the chatbot initiation is triggered via a website or an application, or a location of the client device. In various embodiments, the one or more fallback methods are specific to each chatbot and/or each network. For example, server 102 may store configuration information associated with a first chatbot including a first fallback method of making a chatbot available via SMS and may store configuration information associated with a second chatbot including a second fallback method of redirection to a website and/or mobile application. In various embodiments, server 102 utilizes the one or more fallback methods in the event that a chatbot is unavailable given the context of a client device attempting to access the chatbot. For example, server 102 may execute a rule to determine a fallback method if a primary invocation method fails.

In various embodiments, specific chatbots and/or chatbot galleries are not available of specific client devices and/or networks. For example, a chatbot may be unavailable because of a client device is not RCS compatible or the client device is connected to a network that the chatbot is not available on. A non-limiting example of server 102 determining a fallback is as follows: server 102 may receive a request for a chatbot conversation and may perform a capability check using a preferred channel of the chatbot (e.g., an invocation method associated with the chatbot, etc.). Server 102 may determine that the client device is RCS compatible and is connected to a network that supports a chatbot and may provide a chatbot identifier (e.g., a SIP URI, etc.) to cause a messaging application of the client device to initiate a RCS conversation with the chatbot. Additionally or alternatively, server 102 may determine that the client device is RCS compatible but is not connected to a network that supports the chatbot, may identify another RCS channel configured for the same chatbot, will issue a capability check associated with RCS channel (e.g., to identify whether the invocation method is available, etc.) and may provide a chatbot identifier (e.g., SIP URI, etc.) associated with the alternative chatbot to the client device. In various embodiments, if the client device is not RCS compatible, server 102 may determine if the chatbot has an SMS channel that is accessible to the client device by comparing the SMS channel's configured country and/or operator codes with the attributes of the client device request (e.g., the request for a chatbot conversation, etc.). In various embodiments, if server 102 identifies a compatible SMS channel, server 102 transmits a URL to the client device to cause a messaging application of the client device to initiate a SMS conversation. Additionally or alternatively, if server 102 does not identify a compatible RCS channel nor a compatible SMS channel, server 102 may determine if there is a web-chat channel configured for the Chabot and may serve a URL to the client device to cause a web browser of the client device to launch a web chat with the chatbot.

At step 350, server 102 may generate a content item implementing at least one invocation method associated with a chatbot of the one or more chatbots. For example, server 102 may generate a message for an augmented message stream. In some embodiments, the content item includes a chatbot gallery that facilitates a user to navigate a number of available chatbots and interact with the available chatbots (e.g., to start a conversation, to retrieve/request information, etc.). Systems and methods of augmenting message streams are discussed in detail in U.S. patent application Ser. No. 17/161,082, filed on Sep. 22, 2020, the entire disclosure of which is incorporated by reference herein.

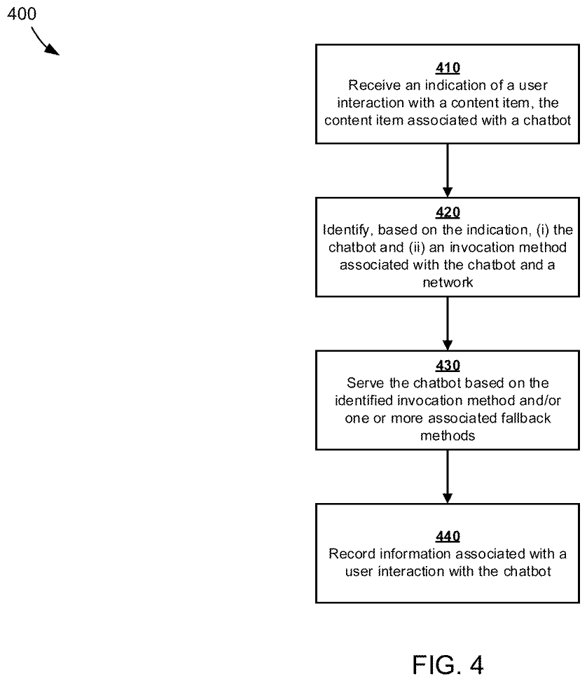

Referring now to FIG. 4, method 400 for serving a chatbot is shown, according to an exemplary embodiment. In various embodiments, system 100 (or a component thereof) implements method 400. For example, server 102 may perform method 400. At step 410, server 102 may receive an indication of a user interaction with a content item. For example, server 102 may receive an indication that a user has interacted with (e.g., selected, etc.) a “click to chat” function in a mobile application. In various embodiments, the content item is associated with a chatbot. For example, a user may browse a chatbot gallery integrated within a messaging application of a client device and may select a chatbot to interact with. In various embodiments, the indication of the user interaction includes context information such as information describing an operating system of a device, a carrier network, a location, a cookie (e.g., a click-tracking cookie, etc.), an interaction identifier (e.g., a fetch-id, etc.) and/or conversion information (e.g., a conversion type, etc.). In some embodiments, the indication includes a chatbot identifier (e.g., identifying a chatbot, a SIP URI, etc.) and/or a network identifier (e.g., identifying a carrier network, etc.). In various embodiments, the indication is received from a client device such as a mobile computing device.

At step 420, server 102 may identify, based on the indication received in step 410, a chatbot and an invocation method associated with the chatbot and the network. For example, server 102 may perform a lookup in a data structure such as a database using a chatbot identifier and/or a network identifier to identify the invocation method. In various embodiments, the invocation method is specific to a context of a client device such as a network the client device is operating on, the client device type, an operating system version of the client device, whether the chatbot initiation is triggered via a website or an application, or a location of the client device. In some embodiments, step 420 includes determining that an invocation method is not available for a client device based on the context of the client device and determining a fallback method.

At step 430, server 102 may serve the chatbot based on the identified invocation method and/or one or more fallback methods. For example, server 102 may include delivering a payload with click-wrapped and shortened-URLs to a client device such as client device 116. In some embodiments, step 430 includes adding the chatbot to a chatbot registry of a mobile communications network. Additionally or alternatively, step 430 may include generating and/or serving a content item to a HTML asset such as a website. For example, step 430 may include generating a “click to chat” JavaScript button that launches a chatbot conversation when clicked and embedding the JavaScript button in a HTML webpage. In various embodiments, the chatbot may be hosted by an external computing system (e.g., a third party computing system, etc.) and may be delivered to an endpoint (e.g., a platform such as a mobile device application, etc.) via system 100. For example, system 100 may act as an intermediary between the external computing system and the endpoint, integrating the chatbot hosted by the external computing system with the endpoint such as a messaging application of a client device. In various embodiments, interaction data associated with the chatbot is routed through server 102 (or another component of system 100) which communicates with the external computing system (e.g., to exchange information associated with the operation of the chatbot, etc.). In various embodiments, server 102 serves the chatbot to a client device such as client device 116. In some embodiments, the chatbot is served to a user according to context data associated with the chatbot. For example, the indication received during step 410 may indicate a user interest in chatbots relating to sports and server 102 may serve a chatbot having a “sports” tag during step 430.

At step 440, server 102 may record information associated with a user interaction with the chatbot. For example, server 102 may record a unique identifier associated with a user interaction with the chatbot (e.g., based on a cookie stored on client device 116, etc.) and/or a timestamp associated with the user interaction. In various embodiments, this unique identifier can be compared with cookie information from a tracking pixel deployed in an HTML environment such as a web page or an HTML email message to determine conversion information associated with user interactions with the chatbot. For example, server 102 may record a first identifier and a timestamp associated with a user interaction with a chatbot and may compare the first identifier to a second identifier from a tracking pixel embedded in a purchase confirmation page of an online retailer to determine that an online purchase resulted from the user interaction with the chatbot.

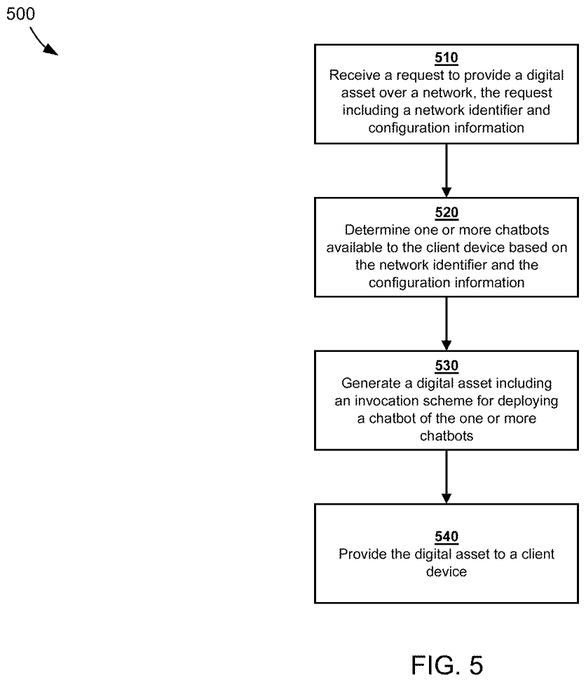

Referring now to FIG. 5, method 500 for providing a digital asset to a client device is shown, according to an exemplary embodiment. In various embodiments, system 100 (or a component thereof) performs method 500. For example, server 102 may perform method 500. At step 510, server 102 may receive a request to provide a digital asset over a network, the request including a network identifier and configuration information. In various embodiments, the request is received from a client device such as a mobile device and/or a computing device. In various embodiments, the configuration information is associated with the client device. For example, the configuration information may include an operating system version of the client device, a location of the client device, and/or the like. An example of code directed to launching retrieving information associated with the client device is as follows:

```
@JavascriptInterface
public String getApplicationInfo( ) throws JSONException {
      if (_appConfig==null)
      {
            _appConfig = new JSONObject( );
            _appConfig.put(“name”, APP_NAME);
            _appConfig.put(“key”, APP_KEY);
      }
      return _appConfig.toString( );
}
```

At step 520, server 102 may determine one or more chatbots available to the client device based on the network identifier and the configuration information. For example, server 102 may perform a lookup on a table using the network identifier and configuration information to determine which chatbots are compatible with the combination of attributes. In various embodiments, step 520 includes querying a data structure such as a database populated during a setup process such as described in FIG. 3.

At step 530, server 102 may generate a digital asset including an invocation scheme for deploying a chatbot of the one or more chatbots on a client device. For example, server 102 may generate a user interface chatbot gallery including the chatbot. In various embodiments, the digital asset includes a chatbot gallery having a number of chatbots. The invocation scheme may include computer executable instructions (e.g., utilizing an API/SDK, etc.) to cause the client device to connect to the chatbot hosted on a computing system via the server 102. For example, the invocation scheme may include an operating system call specific to an operating system running on the client device that causes the client device to generate a messaging interface to communicate with server 102 which communicates with a computing system hosting the chatbot such that a user using the client device can interact with the chatbot as if they were connected to the chatbot directly. In some embodiments, the digital asset is customized to an application of the client device. For example, server 102 may receive the request in step 510 from a client device running a mobile application and server 102 may generate the digital asset to include user interface elements (e.g., formatting, graphics, etc.) specific to the mobile application.

At step 540, server 102 may provide the digital asset to the client device. For example, server 102 may transmit instructions to the client device to cause the client device to display a chatbot gallery including the one or more chatbots that are available to the client device. In some embodiments, step 540 includes causing the client device to initiate a connection with the chatbot within an application of the client device. In various embodiments, the digital asset facilitates a user using the client device to interact with the chatbot. For example, a user may select a “click to chat” option associated with the digital asset and may be connected with an associated chatbot. An example of code directed to launching a chatbot conversation is as follows:

```
@JavascriptInterface
Public void launchConversation(String name, String uri){
  Intent intent = new Intent(Intent.ACTION_VIEW,
  Uri.parse(“sms:” + name));
  startActivity(intent);
}
```

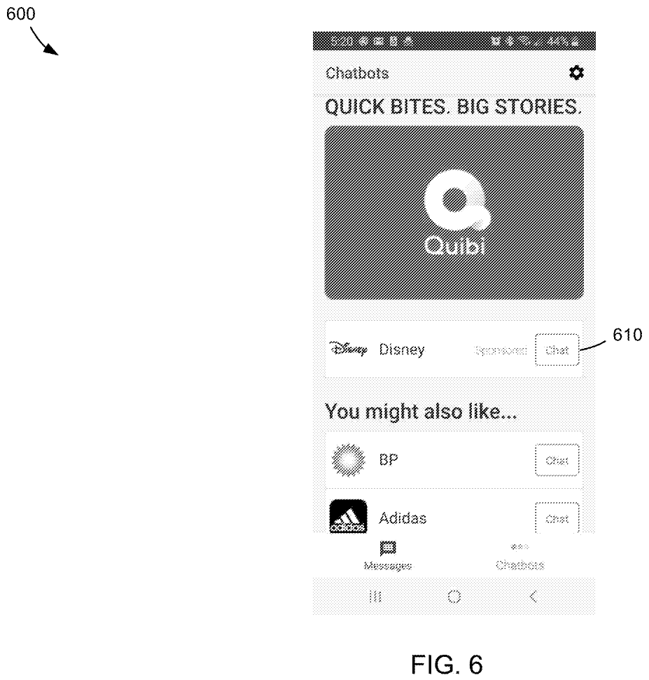

Referring now to FIG. 6, chatbot gallery 600 for displaying one or more chatbots is shown, according to an exemplary embodiment. In various embodiments, gallery 600 is displayed on a client device such as client device 116. For example, server 102 may transmit a digital asset and/or content such as a content item to client device 116 to cause client device 116 to display gallery 600. In various embodiments, gallery 600 facilitates user interaction with one or more chatbots. For example, a user may click on chat 610 to launch a chatbot conversation. In various embodiments, server 102 facilitates promoting one or more chatbots within gallery 600. In various embodiments, gallery 600 is displayed within an existing application on client device 116. For example, gallery 600 may be displayed within a native messaging application of client device 116.

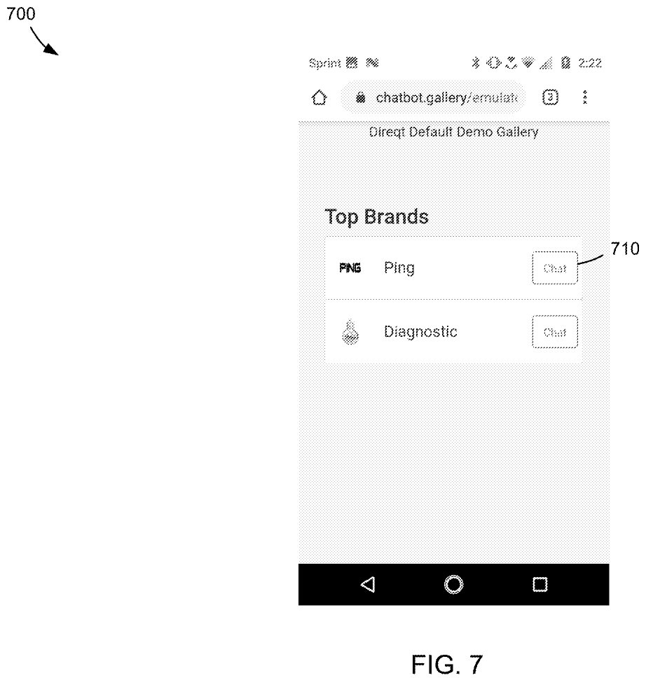

Referring to FIG. 7, chatbot gallery 700 for displaying one or more chatbots is shown, according to an exemplary embodiment. In various embodiments, gallery 700 is displayed on a client device such as client device 116. For example, server 102 may transmit a digital asset and/or content such as a content item to client device 116 to cause client device 116 to display gallery 700. In various embodiments, gallery 700 facilitates user interaction with one or more chatbots. For example, a user may click on chat 710 to launch a chatbot conversation. In various embodiments, server 102 facilitates promoting one or more chatbots within gallery 700. In various embodiments, gallery 700 may be displayed via web browser of client device 116.

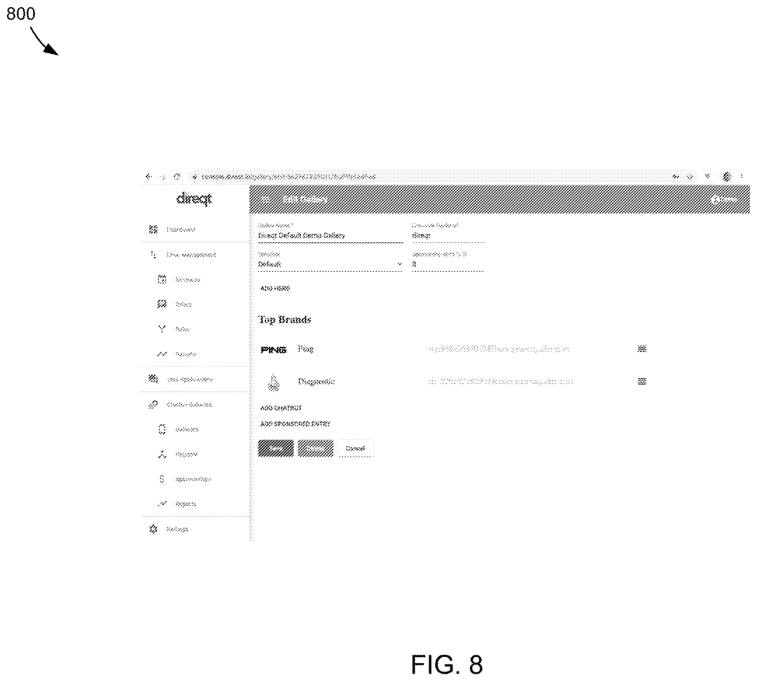

Referring now to FIG. 8, menu 800 for editing a chatbot gallery is shown, according to an exemplary embodiment. In various embodiments, menu 800 is displayed on a client device via web console 108. For example, web console 108 may display menu 800 on a web browser of client device 116. In various embodiments, menu 800 facilitates customer management of a chatbot gallery. For example, a user may add, remove, and/or modify a list of chatbots included in a chatbot gallery via menu 800. In various embodiments, menu 800 facilitates retrieving a link to a chatbot gallery. For example, a customer may retrieve a link from menu 800 and insert the link in a webpage to display the chatbot gallery and/or one or more chatbots associated with the chatbot gallery to a user.

In some embodiments, a customer may generate a content item such as a “click to call” button via menu 800 for embedding in a HTML environment. In various embodiments, menu 800 may integrate with an API interface to generate a link for providing access to a chatbot gallery. Links may include a text or card component and an action component. A card component may include one or more text strings and optional media such as an image or video. Actions may include simple web hyperlinks, click-to-call buttons, or may open maps or other associated applications on a subscriber's device. Not all gateways support all action types, so, for example, a link intended for SMS delivery may only support simple web (HTTP) links as actions. Links may also be defined with one or more customer-specified properties. These properties are not interpreted by the advertisement server, but instead are provided to the chatbot agent as part of a callback. They allow server 102 to track custom data associated with a link, such as a stock keeping unit (SKU) number or other internal information.

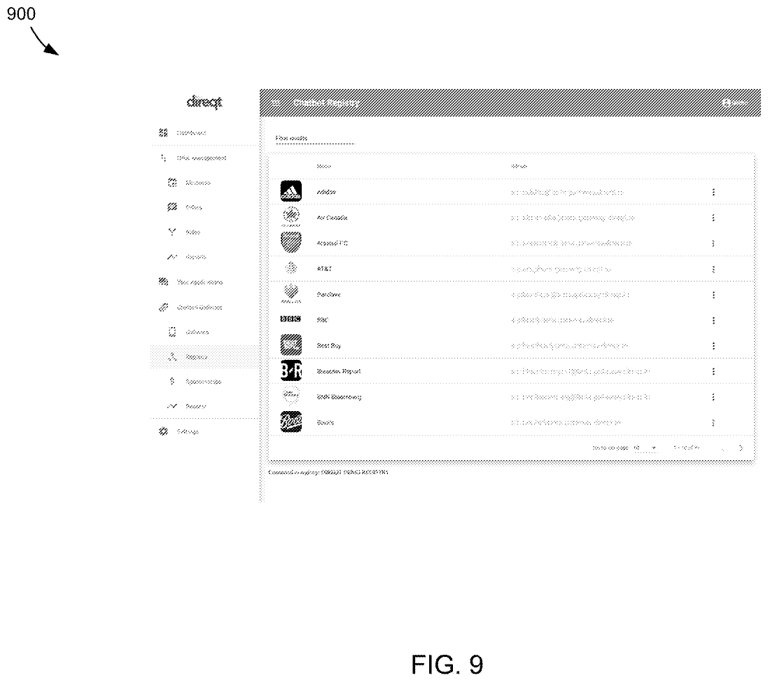

Referring now to FIG. 9, menu 900 for managing chatbots associated with a chatbot gallery is shown, according to an exemplary embodiment. In various embodiments, menu 900 is displayed on a client device via web console 108. For example, web console 108 may display menu 900 on a web browser of client device 116. In various embodiments, menu 900 facilitates customer management of a chatbot gallery. For example, a user may add, remove, and/or modify a list of chatbots included in a chatbot gallery via menu 900. In various embodiments, menu 800 facilitates retrieving a link to a chatbot gallery. In various embodiments, a customer may retrieve an identifier (e.g., a SIP URI, etc.) associated with a chatbot via menu 900. In various embodiments, a user associated with a network such as a cellular network may use menu 900 to manage one or more chatbots available on the network.

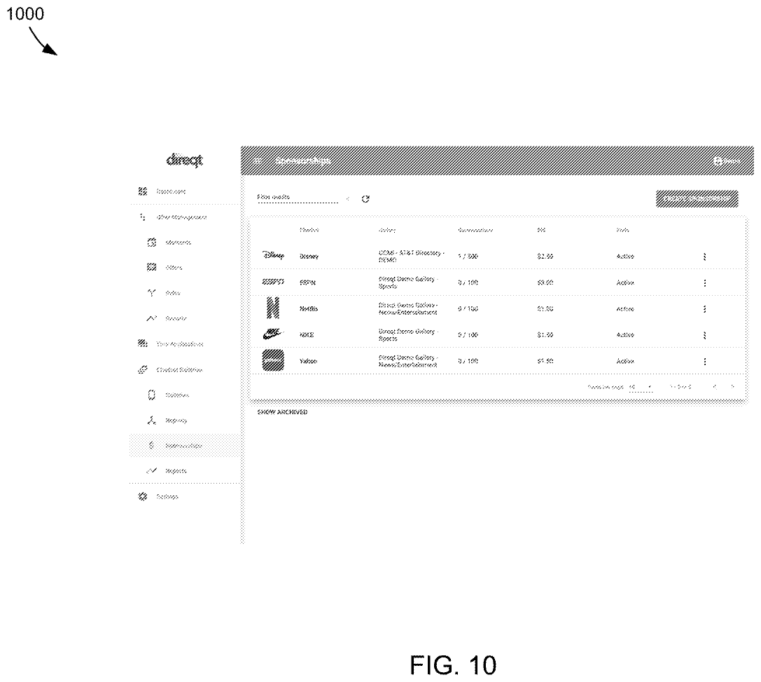

Referring now to FIG. 10, menu 1000 for managing sponsorships is shown, according to an exemplary embodiment. In various embodiments, menu 1000 is displayed on a client device via web console 108. For example, web console 108 may display menu 1000 on a web browser of client device 116. In various embodiments, menu 1000 facilitates managing sponsorships associated with one or more chatbots in a chatbot gallery. For example, a provider of a chatbot may use menu 1000 to generate a promotional/advertising campaign to promote user interaction with the chatbot. In various embodiments, server 102 may promote a chatbot in a chatbot gallery in response to receiving user input via menu 1000. For example, server 102 may display a chatbot higher in a list of chatbots. As another example, server 102 may generate a notification on a device of a user to interact with the chatbot.

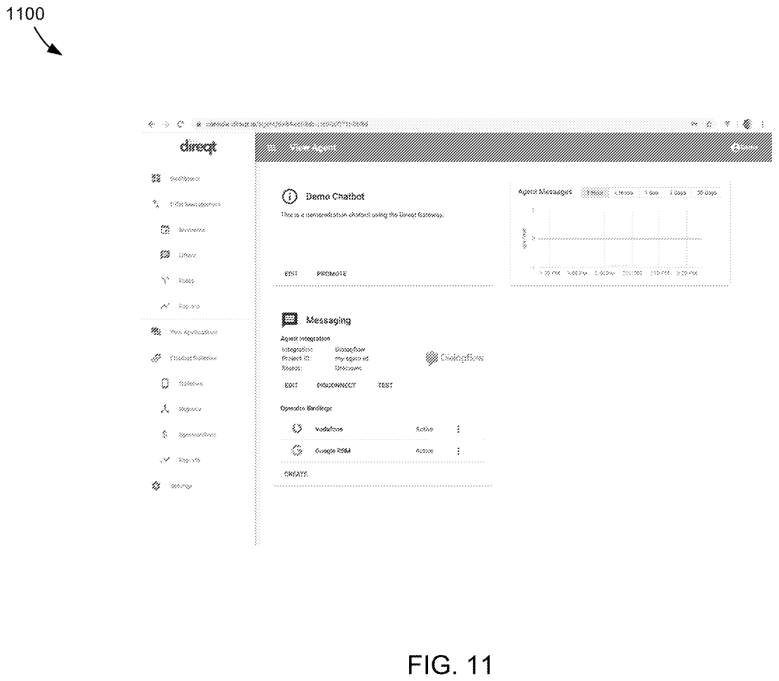

Referring now to FIG. 11, menu 1100 for viewing analytics associated with a chatbot is shown, according to an exemplary embodiment. In various embodiments, menu 1100 is displayed on a client device via web console 108. For example, web console 108 may display menu 1100 on a web browser of client device 116. In various embodiments, menu 1100 facilitates viewing analytics associated with the operation of a chatbot. For example, a user may view a number of conversations a chatbot has engaged in over a period of time. In some embodiments, menu 1100 may display information associated with a chatbot. For example, menu 1100 may display one or more networks that the chatbot is available on and/or configuration information associated with the chatbot. In some embodiments, menu 1100 facilitates managing the operation of the chatbot. For example, a user may promote a chatbot (e.g., start a promotion campaign, etc.) via menu 1100.

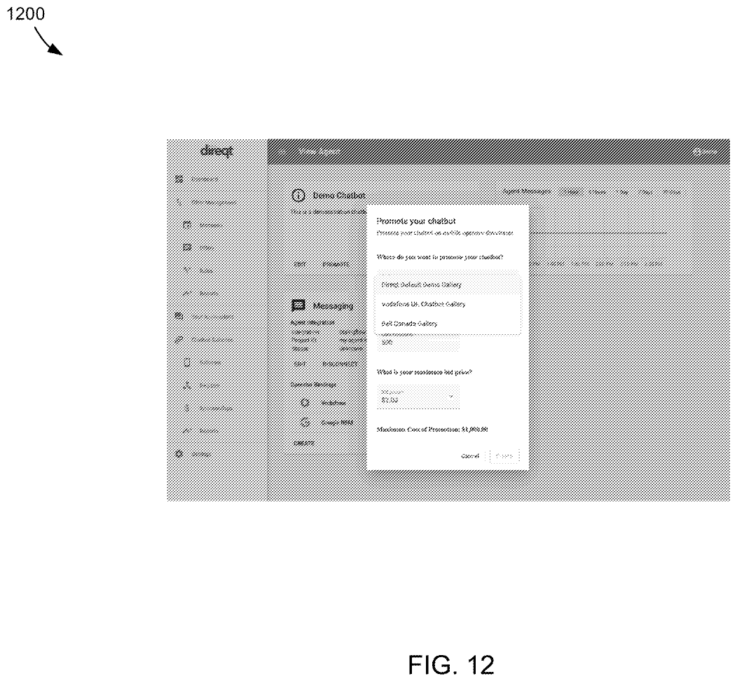

Referring now to FIG. 12, menu 1200 for promoting a chatbot is shown, according to an exemplary embodiment. In various embodiments, menu 1200 is displayed on a client device via web console 108. For example, web console 108 may display menu 1200 on a web browser of client device 116. In various embodiments, menu 1200 may be displayed in response to a user selection to promote a chatbot (e.g., via menu 1100 of FIG. 11, etc.). In various embodiments, a user may select a chatbot gallery, a conversation count, and a bid price associated with a chatbot promotion via menu 1200. In various embodiments, server 102 may promote a chatbot in one or more chatbot galleries in response to receiving user input via menu 1200.

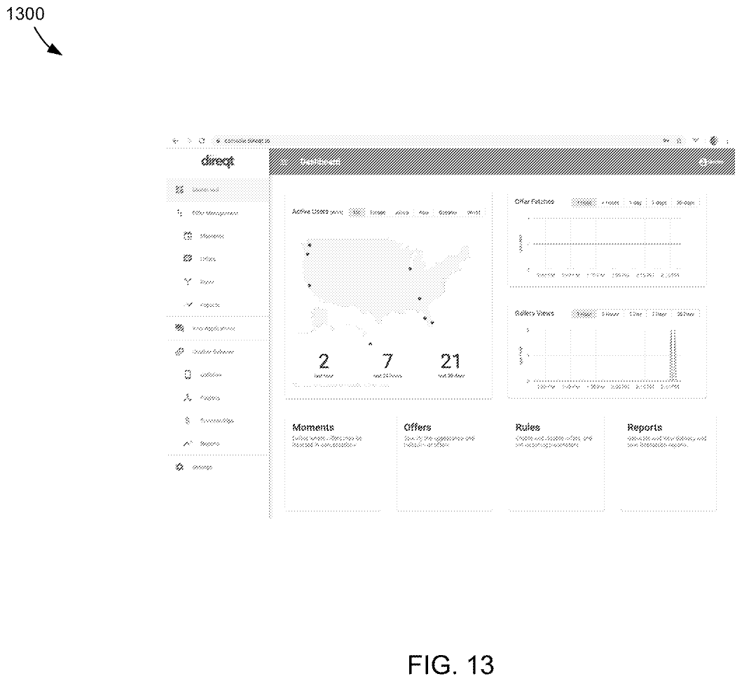

Referring now to FIG. 13, dashboard 1300 for viewing analytics associated with operation of a chatbot and/or chatbot gallery is shown, according to an exemplary embodiment. In various embodiments, dashboard 1300 is displayed on a client device via web console 108. For example, web console 108 may display dashboard 1300 on a web browser of client device 116. In various embodiments, dashboard 1300 facilitates viewing analytics associated with the operation of a chatbot. For example, a user may view a number of conversations a chatbot has engaged in over a period of time. In some embodiments, dashboard 1300 may display information associated with a chatbot. In various embodiments, dashboard 1300 may display a number of chatbot gallery view associated with a time period. In some embodiments, a user may view promotional/advertising campaign analytics via dashboard 1300. For example, dashboard 1300 may display a number of moments, offers, rules, and/or reports associated with a chatbot and/or chatbot gallery.

The foregoing method descriptions and the process flow diagrams are provided merely as illustrative examples and are not intended to require or imply that the steps of the various embodiments must be performed in the order presented. The steps in the foregoing embodiments may be performed in any order. Words such as “then,” “next,” etc. are not intended to limit the order of the steps; these words are simply used to guide the reader through the description of the methods. Although process flow diagrams may describe the operations as a sequential process, many of the operations can be performed in parallel or concurrently. In addition, the order of the operations may be re-arranged. A process may correspond to a method, a function, a procedure, a subroutine, a subprogram, and the like. When a process corresponds to a function, the process termination may correspond to a return of the function to a calling function or a main function.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

Embodiments implemented in computer software may be implemented in software, firmware, middleware, microcode, hardware description languages, or any combination thereof. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the invention. Thus, the operation and behavior of the systems and methods were described without reference to the specific software code being understood that software and control hardware can be designed to implement the systems and methods based on the description herein.

When implemented in software, the functions may be stored as one or more instructions or code on a non-transitory computer-readable or processor-readable storage medium. The steps of a method or algorithm disclosed herein may be embodied in a processor-executable software module, which may reside on a computer-readable or processor-readable storage medium. A non-transitory computer-readable or processor-readable media includes both computer storage media and tangible storage media that facilitate transfer of a computer program from one place to another. A non-transitory processor-readable storage media may be any available media that may be accessed by a computer. By way of example, and not limitation, such non-transitory processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that may be accessed by a computer or processor. Disk and disc, as used herein, include compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

While various aspects and embodiments have been disclosed, other aspects and embodiments are contemplated. The various aspects and embodiments disclosed are for purposes of illustration and are not intended to be limiting, with the true scope and spirit being indicated by the following claims.

What is claimed is:

1. A method for providing an asset over a network, comprising:
receiving, by a first computing system from a client device, a request to provide a digital asset over a network, the request including a network identifier and configuration information associated with the client device;
determining, by the first computing system, one or more chatbots available to the client device based on the network identifier and the configuration information associated with the client device;
generating, by the first computing system, the digital asset including an invocation scheme for deploying a chatbot of the one or more chatbots on the client device, the invocation scheme configured to connect the chatbot hosted on a second computing system to the client device through the first computing system; and
providing, by the first computing system, the digital asset to the client device.

2. The method of claim 1, wherein the digital asset enables a user using the client device to interact with the chatbot hosted on the second computing system.

3. The method of claim 1, wherein the network includes a cellular network.

4. The method of claim 1, wherein deploying the chatbot of the one or more chatbots on the client device includes causing the client device to initiate a connection with the chatbot within an application of the client device.

5. The method of claim 1, wherein deploying the chatbot of the one or more chatbots on the client device includes causing the client device to display a user interface gallery which includes the chatbot.

6. The method of claim 1, wherein the digital asset includes a pointer to the first computing system.

7. The method of claim 1, wherein providing the digital asset to the client device includes embedding the digital asset in a HyperText Markup Language (HTML) asset.

8. A system for providing access to an asset, comprising:
one or more processors coupled to memory, the one or more processors configured to:
receive, from a client device, a request to provide a digital asset over a network, the request including a network identifier and configuration information associated with the client device;
determine one or more chatbots available to the client device based on the network identifier and the configuration information associated with the client device;
generate the digital asset including an invocation scheme for deploying a chatbot of the one or more chatbots on the client device, the invocation scheme configured to connect the chatbot hosted on a second computing system to the client device through the system; and
provide the digital asset to the client device.

9. The system of claim 8, wherein the digital asset enables a user using the client device to interact with the chatbot hosted on the second computing system.

10. The system of claim 8, wherein the network includes a cellular network.

11. The system of claim 8, wherein deploying the chatbot of the one or more chatbots on the client device includes causing the client device to initiate a connection with the chatbot within an application of the client device.

12. The system of claim 8, wherein deploying the chatbot of the one or more chatbots on the client device includes displaying a user interface gallery which includes the chatbot.

13. The system of claim 8, wherein the digital asset includes a pointer to the system.

14. The system of claim 8, wherein providing the digital asset to the client device includes embedding the digital asset in a HyperText Markup Language (HTML) asset.

15. A non-transitory computer-readable storage medium having instructions stored thereon that, when executed by one or more processors, cause the one or more processors to perform operations comprising:
receiving, from a client device, a request to provide a digital asset over a network, the request including a network identifier and configuration information associated with the client device;
determining one or more chatbots available to the client device based on the network identifier and the configuration information associated with the client device;
generating the digital asset including an invocation scheme for deploying a chatbot of the one or more chatbots on the client device, the invocation scheme configured to connect the chatbot hosted on a second computing system to the client device through the one or more processors; and
providing the digital asset to the client device.

16. The non-transitory computer-readable storage medium of claim 15, wherein the digital asset enables a user using the client device to interact with the chatbot hosted on the second computing system.

17. The non-transitory computer-readable storage medium of claim 15, wherein the network includes a cellular network.

18. The non-transitory computer-readable storage medium of claim 15, wherein deploying the chatbot of the one or more chatbots on the client device includes at least one of (i) causing the client device to initiate a connection with the chatbot within an application of the client device or (ii) displaying a user interface gallery which includes the chatbot on the client device.

19. The non-transitory computer-readable storage medium of claim 15, wherein the digital asset includes a pointer to the one or more processors.

20. The non-transitory computer-readable storage medium of claim 15, wherein providing the digital asset to the client device includes embedding the digital asset in a HyperText Markup Language (HTML) asset.
